(19) United States
(12) Patent Application Publication
(10) Pub. No.: US 2020/0130287 A1
(43) Pub. Date: Apr. 30, 2020

(54) Equipment for sticking plastic parts of long rods

(71) Applicant: Mengxiao Ye, Ningbo City (CN)

(72) Inventor: Mengxiao Ye, Ningbo City (CN)

(21) Appl. No.: 16/726,824

(22) Filed: Dec. 25, 2019

(30) Foreign Application Priority Data
Sep. 6, 2019 (CN) 2019108426842

(51) Int. Cl. B29C 65/50; B29C 65/78; B65H 35/06

(52) U.S. Cl. CPC B29C 65/50; B65H 35/06; B29C 65/78

(57) ABSTRACT

The invention discloses an equipment for sticking plastic parts of long rods, which includes a casing. The casing is provided with a clamping cavity. The clamping cavity is provided with a clamping device for clamping a fixed component and driving the component to rotate. A glue sticking box is slidably connected to the upper end surface of the chassis. The glue sticking box is provided with a glue sticking cavity communicating with the clamping cavity. The glue sticking cavity is provided with a tape for pulling out and pasting the tape. To the glue applying device on the part, a power device located behind the glue applying device is provided in the glue applying chamber, and the power device is used to drive the movement of the glue applying device. A cutting device located on the left side of the gluing device, and a supply device for storing and supplying adhesive tape on the left side of the cutting device is provided in the gluing chamber. The invention can realize automatic gluing of long-rod plastic parts. Can set different glue length, and more convenient to install and remove parts.

### CROSS-REFERENCES TO RELATED APPLICATIONS

The present application claims priority from Chinese application No. 2019108426842 filed on Sep. 6, 2019 which is hereby incorporated by reference in its entirety.

### FIELD OF TECHNOLOGY

The invention relates to the technical field of sticking plastic parts, and in particular relates to an equipment for sticking plastic parts of long rods.

### TECHNICAL FIELD

Plastic parts have been widely used due to their light weight, especially for long-bar plastic parts. In order to enhance the connection strength of long-bar parts, adhesive tapes are usually applied to the weak areas of long-bar parts. Generally, the sticking is on the tape, and then it is wound on the tray to supply the glue. The current glueing work mainly uses manual glue. The manual glueing process is to peel the glue from the tape and then peel Good glue is applied to the parts where the parts are glued. Manual glueing has low efficiency, and manual glue is easy to stain the glue with dust, which affects the later glue quality. device.

### CONTENT OF THE INVENTION

### Technical Problem

At present, the pasting of long rod parts is mainly by manual pasting, the pasting efficiency is low, and the pasting quality is poor.

In order to solve the above problem, a glue sticking device for long rod type plastic parts is designed in this example. A glue sticking device for long rod type plastic parts in this example includes a case, and the case is provided with a clamping cavity. The holding cavity is provided with a clamping device for holding the fixed part and driving the part to rotate. An adhesive box is slidably connected to the upper end surface of the case. The adhesive box is provided with an adhesive communicating with the clamping cavity. A glue cavity is provided with a glue-pulling device for pulling the adhesive tape and attaching the tape to a part. The glue-releasing cavity is provided with a power device located behind the glue-pulling device. The device is used for driving the glue-pulling device to move. A cutting device located on the left side of the glue-pulling device is provided in the glue-applying cavity. The cutting device includes a piston fixedly connected to the inner wall of the rear side of the glue-applying cavity. A cylinder, a piston cavity provided in the piston cylinder, a piston slidingly connected to the piston cavity, a pressure rod fixedly connected to the lower end surface of the piston and extending downward into the clamping cavity, fixed A pressure connected to the pressure rod and located in the clamping cavity A suction cup fixedly connected to the inner wall on the rear side of the glue cavity and located on the lower side of the pressure block; a cylinder fixedly connected to the inner wall on the rear side of the glue cavity and located on the upper right side of the piston cylinder; An air cavity in the cylinder, a sub-slid slidably connected to the air cavity, a cutting blade fixedly connected to a lower end surface of the sub-slid and extending downward into the clamping cavity, the sub-slider A connecting pipe is connected between the sliding plug and the upper inner wall of the piston cavity, and the secondary sliding plug is used to drive the cutting knife to move downward to realize the cutting of the adhesive tape. At the same time, the air flow generated by the secondary sliding plug is moved downward to pass through. The connecting pipe drives the piston to press down the clamp to realize tightly fixing the tape, and a supply device for storing and supplying the tape is provided in the glue sticking chamber on the left side of the cutting device.

Preferably, the sliding resistance between the sticking box and the case is large, so that the sticking box and the case do not slip during the normal sticking process.

Wherein, the clamping device includes a secondary air pump fixedly connected to the inner wall on the right side of the clamping cavity, and a secondary motor shaft extending back and forth into the clamping cavity is rotatably connected to the secondary air pump, and the secondary motor A secondary motor fixedly connected to the inner wall on the rear side of the clamping cavity is dynamically connected to the shaft, and a driven shaft extending rearwardly is rotatably connected to the inner wall on the front side of the clamping cavity. The driven shaft and the secondary A sliding cylinder is fixedly connected to the motor shaft, and the two sliding cylinders are symmetrical front to back. The sliding cylinder on the rear side is located on the front side of the auxiliary air pump. The sliding cylinder is provided with a pneumatic cavity. A sliding plug is slidingly connected, and a push rod is fixedly connected to an end face of the sliding plug near the center of symmetry. A return spring is connected between the sliding plug and an inner wall of the pneumatic cavity near the symmetrical center. A side close to the center of symmetry extends into the clamping cavity, and a clamping box is fixedly connected to an end surface of the side of the cylinder near the center of symmetry. The clamping box is provided with a clamping cavity, and the push rod is closer to the center of symmetry. One side extends into the clamping cavity, and the push rod is fixed on A trapezoidal block located in the clamping cavity is connected, and two vertically symmetrical clamping blocks are slidingly connected to the left inner wall of the clamping cavity. A clamping spring is connected between the clamping spring and the trapezoidal block, the clamping spring can clamp and fix the workpiece, and the auxiliary air pump is connected with the pneumatic cavity on the front side. An air pipe, a connection pipe is connected between the auxiliary air pump and the pneumatic cavity at the rear side.

Preferably, the gas pipe is provided with a solenoid valve for exhausting.

Wherein, the glue-pulling device includes a slide table fixedly connected to the inner wall of the glue cavity and located on the right side of the cylinder, and an auxiliary rack is slidably connected to the upper end surface of the slide table. A side end surface is fixedly connected, a left side end surface of the auxiliary rack is fixedly connected with a sub slide table, a left side end surface of the sub slide table is slidably connected with a rack, and a left side end surface of the rack is fixedly connected with energy. A negative suction pad is used to adsorb the auxiliary suction cup. The upper end surface of the auxiliary suction cup is fixedly connected with a wedge-shaped block. The inner wall of the rear side of the glue cavity is fixedly connected with an air pump located on the upper side of the auxiliary rack. A secondary hose is connected between the secondary suction cups.

Wherein, the power device includes a pulley shaft that is rotatably connected to the inner wall of the rear side of the glue cavity and extends forward, and the pulley shaft is located on the right side of the rack, and the pulley shaft is fixedly connected with the pulley shaft. The auxiliary gear of the rack meshing connection is fixedly connected with the auxiliary pulley at the rear side of the auxiliary gear, and a forwardly extending motor shaft is rotatably connected to the inner wall of the rear side of the glue cavity, and The motor shaft is located at the lower right side of the pulley shaft, and a motor fixedly connected to the inner wall on the rear side of the glue cavity is dynamically connected to the motor shaft. The motor shaft is rotatably connected with a pulley, and the pulley A V-belt is connected to the auxiliary pulley. A spline cavity with an opening facing forward is provided in the pulley. A spline on the motor shaft is connected with a spline that can be splined to the spline cavity. A gear on the motor shaft is rotatably connected with a gear located on the front side of the spline barrel, and the gear is provided with a sub-spline cavity with an opening facing backward and can be splined with the spline barrel, and The auxiliary spline cavity is in mesh connection with the auxiliary rack, and the inner wall of the front side of the auxiliary spline cavity is fixedly connected An electromagnet, a compression spring is connected between the electromagnet and the spline cylinder.

Wherein, the cutting device comprises an exhaust pipe fixedly connected to the right end face of the piston chamber, and an inner wall of the upper side of the exhaust pipe is provided with a sliding hole with an opening facing upward, and the sliding hole is slidably connected in the sliding hole. There is a slide block that can cut off the exhaust pipe, that is, the slide block can make the piston cavity and the glue cavity not communicate with each other, and the slide block can make the slide hole disconnect with the exhaust pipe A connecting rod extending downward to the outside of the end face of the exhaust pipe is fixedly connected to the lower end surface of the sliding block, and the connecting rod can abut the wedge block, and the piston and the piston chamber A spring is connected between the side inner walls, and the connecting pipe is provided with two auxiliary check valves distributed from left to right, and the auxiliary check valve on the left side is located where the piston cavity communicates with the connecting pipe. A check valve is provided on the lower end surface of the suction cup, an air pipe is connected between the check valve and the air pump, and an oblique located on the right side of the cutting blade is fixedly connected to the lower end surface of the auxiliary slide. Block, a tension spring is connected between the auxiliary slide plug and the inner wall on the upper side of the air cavity, and on the inner wall on the right side of the air cavity There is a secondary sliding hole with an opening facing to the right. A sliding rod that can abut the slant block is slidably connected in the secondary sliding hole. A convex end located in the adhesive cavity is fixedly connected to the upper end surface of the sliding rod. Block, a hose is connected between the right end face of the air cavity and the auxiliary air pump, a valve body connected to the air cavity is connected to the hose, and the valve body is fixedly connected to the valve body On the right end face of the air cavity, a slide cavity with an opening facing downward is provided on the inner wall of the upper side of the valve body, and a slide block is provided in the slide cavity to make the air cavity and the auxiliary air pump incommunicable. An L-shaped hole with an opening leftward and downward is provided, the L-shaped hole communicates with the glue cavity and can communicate with the air cavity, and the lower end surface of the slider is fixedly connected with a downward extension to the cavity. The connecting rod in the glue cavity, and the connecting rod is in contact with the projection, a damper located on the lower side of the valve body is fixedly connected to the right end face of the air cavity, and the connecting rod passes through The damper, which has a large damping when the connecting rod is lowered, so that the slider moves down slowly, so that the air The cavity has sufficient time to exhaust air through the L-shaped hole, and the hose is provided with a flow valve located on the right side of the valve body.

Preferably, the auxiliary one-way valve communicates one-way from top to bottom, and the one-way valve communicates one-way from bottom to top. By adjusting the flow of the flow valve, the cutting knife can be controlled to move the cutting tape downward. Time, so that the length of the tape wound on the workpiece can be changed.

Wherein, the supply device includes an auxiliary air pump fixedly connected to the inner wall on the rear side of the glue cavity, the auxiliary air pump is located on the left side of the piston cylinder, and an auxiliary air pipe is connected between the auxiliary air pump and the air pipe. A conveying shaft extending forward to the glue sticking cavity is rotatably connected in the auxiliary air pump. A conveying wheel is fixedly connected to the conveying shaft, and a tape passes around the lower end face of the conveying wheel. A mandrel located on the upper left side of the conveying shaft is rotatably connected to the rear inner wall, and the mandrel extends forward, and a storage wheel for storing tape is fixedly connected to the mandrel.

The beneficial effect of the present invention is that the clamping mechanism of the present invention can quickly clamp parts, and can automatically release the parts after the completion of the glue application, which is convenient for workers to install and disassemble the parts. The pulling tape mechanism adsorbs the tape through the negative pressure suction cup and passes the two groups. The rack and pinion mechanism realizes the movement of pulling the tape and attaching the tape to the parts. After that, the clamping mechanism can drive the parts to rotate to realize the tape winding movement. After winding to a set length, the cutting mechanism can cut the tape, and the cutting mechanism drives the fixing mechanism. The fixed adhesive tape is convenient for the next time the tape is pulled out. At the same time, different glue lengths can be set by adjusting the flow valve in the cutting mechanism. Therefore, the invention can automatically glue long plastic parts and set different glues. Glue length, and more convenient to install and remove parts.

### BRIEF DESCRIPTION OF THE DRAWINGS

For ease of description, the present invention is described in detail by the following specific embodiments and the accompanying drawings.

FIG. 1 is a schematic diagram of the overall structure of a long-bar type plastic part gluing device according to the present invention;

FIG. 2 is a schematic structural diagram of the direction “A-A” of FIG. 1;

FIG. 3 is a schematic structural diagram in a direction “B-B” of FIG. 1;

FIG. 4 is a schematic structural diagram in a direction “C-C” of FIG. 1;

FIG. 5 is a schematic structural diagram of the “D-D” direction of FIG. 1;

6 is an enlarged schematic view of the structure at “E” in FIG. 1;

FIG. 7 is an enlarged schematic view of the structure at “F” in FIG. 1.

### DETAILED DESCRIPTION OF THE INVENTION

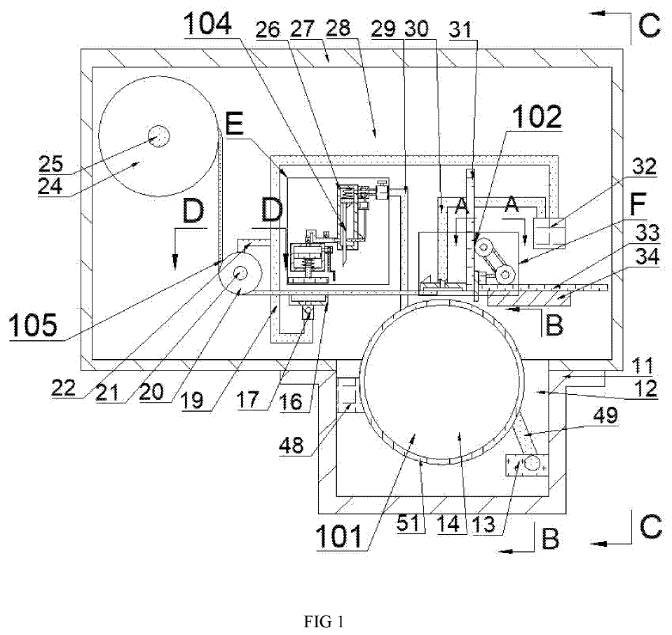

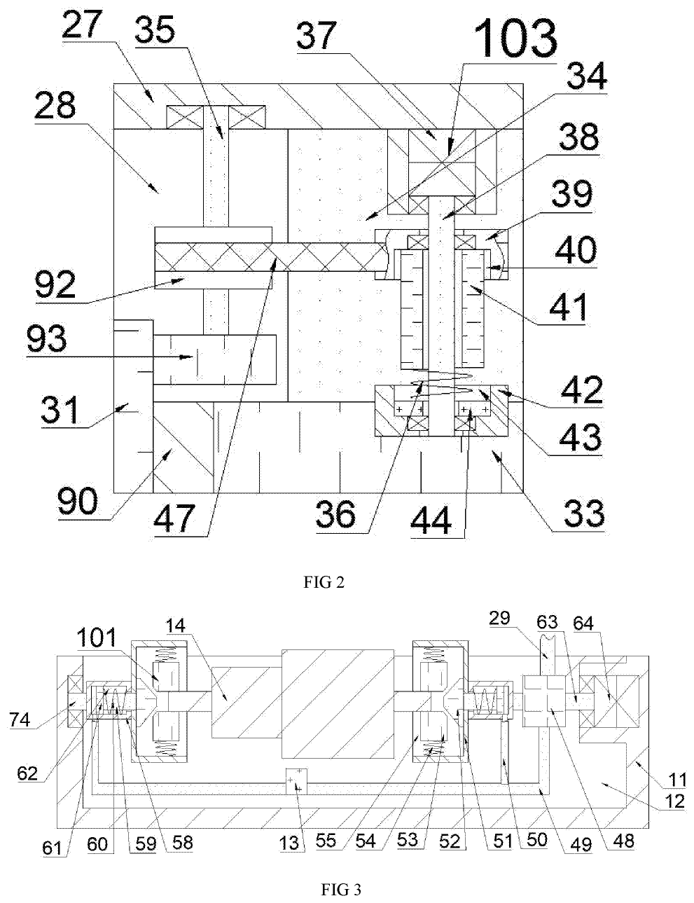

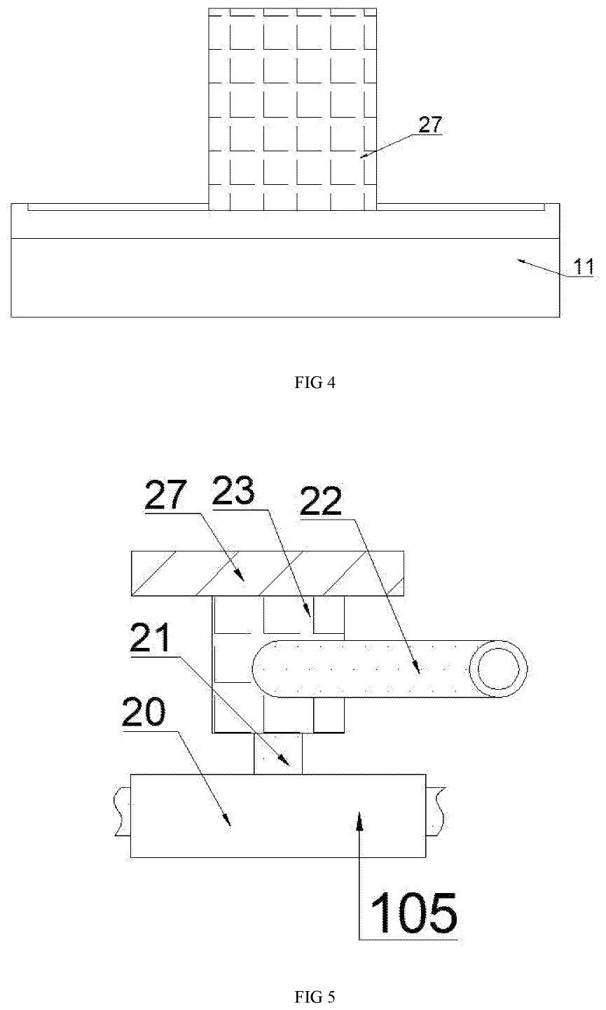

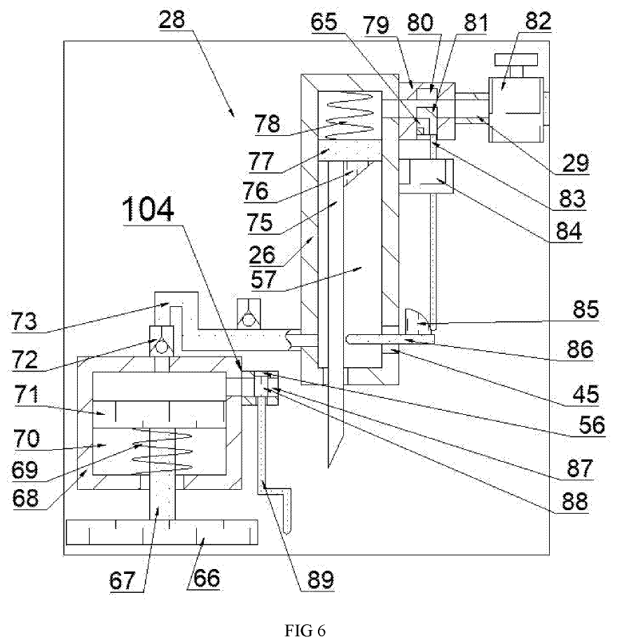

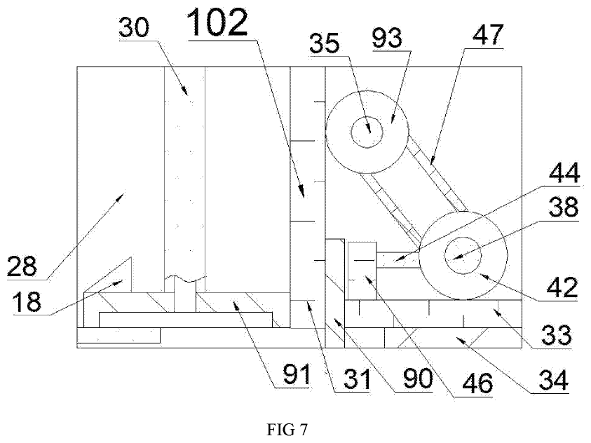

The present invention is described in detail below with reference to FIGS. 1 to 7. For convenience of description, the orientation described below is defined as follows: the up-down, left-right, front-back direction described below is consistent with the up-down, left-right, front-back direction of the projection relationship of FIG. 1 itself.

The present invention relates to a sticking device for plastic parts of a long rod type, which is mainly used for sticking plastic parts. The present invention will be further described below with reference to the accompanying drawings of the present invention:

The invention relates to a device for sticking plastic parts of long rods according to the present invention. The device includes a casing 11. The casing 11 is provided with a clamping cavity 12, and the clamping cavity 12 is provided for clamping a fixed part and driving the part to rotate. A clamping device 101 is provided on the upper end surface of the case 11 with a glue sticking box 27 slidably disposed therein. The glue sticking box 27 is provided with a glue sticking cavity 28 communicating with the gripping cavity 12. A bonding device 102 is provided in 28 for pulling the adhesive tape and attaching the adhesive tape to the part. The bonding chamber 28 is provided with a power device 103 located behind the bonding device 102. The power device 103 is used for In order to drive the gluing device 102 to move, a cutting device 104 located on the left side of the gluing device 102 is provided in the gluing device 28. The cutting device 104 includes a fixed connection to the rear side of the gluing device 28. A piston cylinder 68 on the inner wall, a piston cavity 70 provided in the piston cylinder 68, a piston 71 slidingly connected to the piston cavity 70, fixedly connected to the lower end surface of the piston 71, and extending downward to The pressure rod 67 in the clamping cavity 12 and a pressure rod fixedly connected to the pressure rod 67 and located in the clamping cavity 12. Block 66, a suction cup 16 fixedly connected to the inner wall on the rear side of the adhesive cavity 28 and located on the lower side of the pressure block 66, fixedly connected to an inner wall on the rear side of the adhesive cavity 28 and located on the upper right of the piston cylinder 68 The air cylinder 26 on the side, an air cavity 57 provided in the air cylinder 26, a sub-slider 77 slidingly connected to the air cavity 57, fixedly connected to the lower end surface of the sub-slider 77 and extending downward to A connecting pipe 73 is connected between the cutting knife 75 in the clamping cavity 12, the auxiliary slide 77 and the upper inner wall of the piston cavity 70, and the auxiliary slide 77 is used to move the cutting downward. The knife 75 moves downward to cut off the tape, and at the same time, the air current generated by the sub-slider 77 moves down through the connecting pipe 73 to drive the piston 71 to press down the clamp to tightly fix the tape. A supply device 105 for storing and supplying the adhesive tape on the left side of the cutting device 104.

Beneficially, the sliding resistance between the sticking box 27 and the chassis 11 is large, so that the sticking box 27 and the chassis 11 will not slip during the normal sticking process.

According to the embodiment, the clamping device 101 will be described in detail below. The clamping device 101 includes a secondary air pump 48 fixedly connected to the inner wall on the right side of the clamping cavity 12. To the auxiliary motor shaft 63 in the clamping cavity 12, the auxiliary motor shaft 63 is dynamically connected to the auxiliary motor 64 fixedly connected to the inner wall on the rear side of the clamping cavity 12, and the front side of the clamping cavity 12 On the inner wall, a driven shaft 74 extending rearward is rotatably connected. The driven shaft 74 and the auxiliary motor shaft 63 are fixedly connected with a sliding cylinder 58 respectively, and the two sliding cylinders 58 are symmetrical in front and rear. The slide cylinder 58 is located on the front side of the auxiliary air pump 48. The slide cylinder 58 is provided with a pneumatic cavity 62, and a sliding plug 61 is slidably connected to the pneumatic cavity 62. The sliding plug 61 is close to the symmetrical center end surface. A push rod 59 is fixedly connected on the upper side, and a return spring 60 is connected between the sliding plug 61 and the inner wall of the pneumatic cavity 62 near the center of symmetry, and the push rod 59 extends to the clamp near the center of symmetry. In the cavity 12, a clamp box 51 is fixedly connected to an end surface of the slide cylinder 58 near the center of symmetry, and the clamp The tool box 51 is provided with a clamping cavity 55. The push rod 59 extends into the clamping cavity 55 toward a side closer to the center of symmetry. The push rod 59 is fixedly connected to the clamping cavity 55. In the trapezoidal block 52, two upper and lower symmetrical clamping blocks 53 are slidably connected to the left inner wall of the clamping cavity 55, and a clamping is connected between the clamping block 53 and the inner wall of the clamping cavity 55 away from the center of symmetry. A spring 54, and the clamping spring 54 may abut the trapezoidal block 52, the clamping spring 54 may clamp and fix the workpiece 14, and the auxiliary air pump 48 communicates with the pneumatic cavity 62 on the front side An air pipe 49 is connected, and a connection pipe 50 is connected between the auxiliary air pump 48 and the pneumatic cavity 62 on the rear side. The auxiliary motor 64 can drive the auxiliary motor shaft 63 and the slide cylinder through rotation. 58 rotation, so as to drive the workpiece 14 to rotate, and the tape is wound on the workpiece 14.

Beneficially, the gas pipe 49 is provided with a solenoid valve 13 for exhausting.

According to the embodiment, the glue-pulling device 102 will be described in detail below. The glue-pulling device 102 includes a slide table 34 fixedly connected to the inner wall of the paste chamber 28 and located on the right side of the cylinder 26. The slide table 34 An auxiliary rack 33 is slidably connected to the upper end surface, 46 is fixedly connected to the rear end surface of the auxiliary rack 33, and an auxiliary sliding table 90 is fixedly connected to the left end surface of the auxiliary rack 33. A rack 31 is slidably connected to the left end surface of the 90. A left side end surface of the rack 31 is fixedly connected with a sub suction pad 91 capable of utilizing a negative pressure adsorption tape, and a wedge block 18 is fixedly connected to the upper end face of the sub suction pad 91. An air pump 32 located on the upper side of the auxiliary rack 33 is fixedly connected to the inner wall on the rear side of the adhesive cavity 28. An auxiliary hose 30 is connected between the air pump 32 and the auxiliary suction cup 91. The auxiliary rack 33 can be moved left and right to realize the movement of pulling the tape, and the rack 31 can be moved downward to realize the glue transportation.

According to an embodiment, the power device 103 is described in detail below. The power device 103 includes a pulley shaft 35 that is rotatably connected to the inner wall of the rear side of the adhesive cavity 28 and extends forward, and the pulley shaft 35 is located in the On the right side of the rack 31, a secondary gear 93 meshed with the rack 31 is fixedly connected to the pulley shaft 35, and a secondary pulley 92 on the rear side of the secondary gear 93 is fixedly connected to the pulley shaft 35 A forwardly extending motor shaft 38 is rotatably connected to the inner wall of the rear side of the glue cavity 28, and the motor shaft 38 is located on the lower right side of the pulley shaft 35. The motor shaft 38 is fixedly connected to the power shaft A motor 37 on the inner wall of the rear side of the glue cavity 28 is connected with a pulley 39 on the motor shaft 38. A V-belt 47 is connected between the pulley 39 and the auxiliary pulley 92, and the belt A spline cavity 40 with an opening facing forward is provided in the wheel 39. A spline cylinder 41 that can be splined to the spline cavity 40 is connected to the motor shaft 38 by sliding keys. The motor shaft 38 is rotatably connected to the motor shaft 38. The gear 42 is located on the front side of the spline cylinder 41, and the gear 42 is provided with an opening facing backward and can be splined with the spline cylinder 41 The auxiliary spline cavity 43 is meshed with the auxiliary rack 33, and an electromagnet 44 is fixedly connected to the inner wall of the front side of the auxiliary spline cavity 43. A compression spring 36 is connected between the spline cylinders 41, and the motor shaft 38 is driven to rotate by the motor 37, and the spline cylinder 41 and the gear 42 are splined to drive the auxiliary teeth. The bar 33 moves left and right.

According to the embodiment, the cutting device 104 is described in detail below. The cutting device 104 includes an exhaust pipe 87 fixedly connected to the right end surface of the piston cavity 70, and an inner wall of the upper side of the exhaust pipe 87 is provided. There is a sliding hole 56 with an opening facing upward, and a sliding block 88 that can cut off the exhaust pipe 87 is slidably connected in the sliding hole 56, that is, the sliding block 88 can make the piston cavity 70 and the glue cavity 28 is not connected, and the sliding block 88 makes the sliding hole 56 not connected to the exhaust pipe 87. The lower end surface of the sliding block 88 is fixedly connected to extend outwardly from the end surface of the exhaust pipe 87. The connecting rod 89 can be in contact with the wedge block 18. A spring 69 is connected between the piston 71 and the inner wall of the lower side of the piston cavity 70. Two sub-check valves 72 distributed from left to right. The sub-check valve 72 on the left side is located at the position where the piston chamber 70 communicates with the connecting pipe 73. A one-way valve is provided on the lower end surface of the suction cup 16. An air pipe 19 is connected between the check valve 17 and the air pump 32. The lower end face of the auxiliary slide 77 is fixedly connected to the cutoff. An inclined block 76 on the right side of the knife 75, a tension spring 78 is connected between the auxiliary sliding plug 77 and the upper inner wall of the air cavity 57, and a right side auxiliary slide is provided on the right inner wall of the air cavity 57 A hole 45 is formed in the auxiliary sliding hole 45 with a pushing rod 86 that can be abutted with the inclined block 76. A convex block located in the adhesive cavity 28 is fixedly connected to an upper end surface of the pushing rod 86. 85. A hose 29 is connected between the right end face of the air cavity 57 and the auxiliary air pump 48, and a valve body 79 connected to the air cavity 57 is connected to the hose 29, and the valve A body 79 is fixedly connected to the right end surface of the air cavity 57. A slide cavity 80 with an opening facing downward is provided on the inner wall of the upper side of the valve body 79. The slide cavity 80 is slidably connected with the air cavity 57 and the auxiliary cavity. The air pump 48 is not connected with a slider 81, and the slider 81 is provided with an L-shaped hole 65 opening to the left and downward, and the L-shaped hole 65 is in communication with the glue cavity 28 and can be connected with the air cavity 57 communicates with, on the lower end surface of the slider 81, a connecting rod 83 extending downward into the adhesive cavity 28 is fixedly connected, and the connecting rod 83 abuts with the projection 85, the air cavity 57 fixed on the right end face There is a damper 84 located on the lower side of the valve body 79, and the connecting rod 83 penetrates the damper 84, and the damper 84 makes the connecting rod 83 lower when it is lowered, so that the slider 81 moves down slowly, so that the air cavity 57 has sufficient time to exhaust air through the L-shaped hole 65, the hose 29 is provided with a flow valve 82 on the right side of the valve body 79, and the auxiliary valve The air flow generated by the air pump 48 can be conveyed into the air cavity 57 through the hose 29 and drives the air cavity 57 to move down to cut off the adhesive tape.

Beneficially, the auxiliary check valve 72 communicates in a single direction from top to bottom, and the check valve 17 communicates in a single direction from bottom to top. By adjusting the flow of the flow valve 82, the cutting knife 75 can be controlled. The time of cutting off the tape can be changed, so that the length of the tape wound on the workpiece 14 can be changed.

According to the embodiment, the supply device 105 is described in detail below. The supply device 105 includes a secondary air pump 23 fixedly connected to the inner wall of the rear side of the glue cavity 28, and the secondary air pump 23 is located on the left side of the piston cylinder 68. An auxiliary air pipe 22 is connected between the auxiliary air pump 23 and the air pipe 19. The auxiliary air pump 23 is rotatably connected with a conveying shaft 21 that extends forward into the adhesive cavity 28. The conveying shaft 21 A conveying wheel 20 is fixedly connected to the upper side, a tape passes around the lower end surface of the conveying wheel 20, and a core shaft 25 located on the upper left side of the conveying shaft 21 is rotatably connected to the inner wall on the rear side of the glue cavity 28, and the core A shaft 25 extends forward, and a storage wheel 24 for storing tape is fixedly connected to the core shaft 25. Air flows through the auxiliary air pipe 22 to drive the auxiliary air pump 23 to work, thereby driving the conveying shaft 21 and the conveying wheel. 20 turns to achieve supply tape.

The following describes in detail the use steps of a long-bar type plastic part pasting equipment in this article with reference to FIGS. 1 to 7:

At the beginning, the clamping block 53 clamps the workpiece 14, and under the action of the return spring 60, the slide 61 and the trapezoidal block 52 are located at the limit away from the center of symmetry, and the trapezoidal block 52 and the clamping block 53 are not in contact, and the electromagnet 44 is energized. Attach the spline cylinder 41, the spline cylinder 41 is splined to the auxiliary spline cavity 43 and disconnected from the spline cavity 40. The auxiliary hose 30 is located at the right limit position, the rack 31 is located at the upper limit position, and the sliding block 88 is located at At the lower limit, the left and right sides of the exhaust pipe 87 are not connected. The slider 81 is located at the lower limit. The piston 71 and the pressure block 66 are located at the lower limit. The pressure block 66 and the suction cup 16 hold the tape. The projection 85 is located at the left limit. In position, the sub-slide 77 is located at the upper limit.

During operation, the motor 37 is started. The motor 37 drives the motor shaft 38 to rotate. The motor shaft 38 drives the spline cylinder 41 to rotate through the feather key connection, the spline cylinder 41 drives the gear 42 to rotate through the spline connection, and the gear 42 drives the auxiliary teeth through the meshing connection. The bar 33 moves to the left, so that the wedge block 18 abuts the connecting rod 89. The wedge block 18 pushes the connecting rod 89 to drive the sliding block 88 to move up, so that the piston chamber 70 exhausts the compressed air in the piston chamber 70 through the exhaust pipe 87. Under the action of the spring 69, the piston 71 moves to the upper limit, at the same time the pressure block 66 moves upward to release the tape, and at the same time starts the air pump 32. The air pump 32 sucks air through the auxiliary suction cup 91 and the auxiliary hose 30, so that a negative pressure is generated at the auxiliary suction cup 91 Adsorb the tape, and send the airflow to the suction cup 16 through the air pipe 19 and the check valve 17. The suction cup 16 discharges the air flow so that the tape does not stick to the suction cup 16. Part of the air flow in the air pipe 19 drives the auxiliary air pump 23 to work through the auxiliary air pipe 22. The air pump 23 drives the conveying shaft 21 and the conveying wheel 20 to rotate, and conveys the tape to the right. At the same time, the motor 37 reverses, and the auxiliary suction cup 91 drives the tape to the right to the right limit. Then the electromagnet 44 loses power. Under the action of the compression spring 36, Spline barrel 41 moves backward The spline cylinder 41 is disconnected from the auxiliary spline cavity 43, the auxiliary spline cavity 43 is splined to the spline cavity 40, and the motor shaft 38 drives the pulley 39 to rotate through the spline connection of the spline cylinder 41 and the pulley 39, The pulley 39 drives the auxiliary pulley 92 and the pulley shaft 35 to rotate through the V belt 47. The pulley shaft 35 drives the rack 31 to move downward through the meshing connection between the auxiliary gear 93 and the rack 31, and the rack 31 drives the auxiliary sucker 91 to move downward. The tape is affixed to the work piece 14. The auxiliary suction cup 91 applies a certain pressure to the tape and the work piece 14 to ensure the flatness of the tape. After that, the motor 37 and the air pump 32 are stopped, and the auxiliary motor 64 is started. The auxiliary motor 64 drives the auxiliary motor shaft 63 to rotate. The auxiliary motor shaft 63 drives the slide cylinder 58 and the clamp box 51 to rotate. The clamp box 51 clamps the workpiece 14 through the clamping block 53 to drive the workpiece 14 to rotate, so that the workpiece 14 rotates and winds the tape. At the same time, the auxiliary motor shaft 63 drives the auxiliary air pump 48 to generate airflow. And sends it into the air cavity 57 through the hose 29, the flow valve 82 and the valve body 79, and pushes the sub-slider 77 down, meanwhile, the air flow in the sub-air pump 48 is sent to the air cavity through the air pipe 49 and the connecting pipe 50 62, and push the slide 61 to move closer to the center of symmetry, During the downward movement of the slider 77, the secondary slider 77 transports the air in the air cavity 57 into the piston cavity 70 to drive the piston 71 and the pressure block 66 down. When the pressure block 66 moves down to the clamping tape, the cutter 75 is cut off. Move the cutting tape down while the oblique block 76 pushes the push rod 86 to the right. The push rod 86 drives the bump 85 to the right and pushes the connecting rod 83 and the slider 81 up, so that the L-shaped hole 65 communicates with the air cavity 57, and It is because the hose 29 is not connected to the air cavity 57. The compressed air in the air cavity 57 is discharged into the adhesive cavity 28 through the L-shaped hole 65. Under the action of the tension spring 78, the auxiliary slide 77 is moved upward and reset, and at the same time With the damper 84 sliding, the connecting rod 83 moves down slowly and pushes the projection 85 to the left to reset. After the workpiece 14 is wrapped and entrained, the air flow in the pneumatic cavity 62 pushes the slider 61, the push rod 59 and the trapezoidal block 52 closer. The symmetry center moves, so that the trapezoidal block 52 and the clamping block 53 abut, and the clamping block 53 is moved to the side far from the symmetry center to release the workpiece 14, while the auxiliary motor 64 is stopped, and the motor 37 is reversed to reset the rack 31 to move upward, thereby After completing a gluing movement, the worker then removes the processed workpiece 14 and loads another one for the gluing 14. After that, the solenoid valve 13 is opened, and the compressed air in the pneumatic cavity 62 is discharged through the connecting pipe 50, the air pipe 49 and the solenoid valve 13, so that the trapezoidal block 52 and the slide 61 are moved and reset to the side away from the center of symmetry, and the trapezoidal block 52 is reset. Out of contact with the clamping block 53, the clamping block 53 clamps and fixes the workpiece 14 again, and performs the next processing.

The beneficial effect of the present invention is that the clamping mechanism of the present invention can quickly clamp parts, and can automatically release the parts after the completion of the glue application, which is convenient for workers to install and disassemble the parts. The pulling tape mechanism adsorbs the tape through the negative pressure suction cup and passes the two groups. The rack and pinion mechanism realizes the movement of pulling the tape and attaching the tape to the parts. After that, the clamping mechanism can drive the parts to rotate to realize the tape winding movement. After winding to a set length, the cutting mechanism can cut the tape, and the cutting mechanism drives the fixing mechanism. The fixed adhesive tape is convenient for the next time the tape is pulled out. At the same time, different glue lengths can be set by adjusting the flow valve in the cutting mechanism. Therefore, the invention can automatically glue long plastic parts and set different glues. Glue length, and more convenient to install and remove parts.

In the above manner, those skilled in the art can make various changes according to the working mode within the scope of the present invention.

1. A glue sticking device for long plastic parts, including a chassis; the casing is provided with a clamping cavity. The clamping cavity is provided with a clamping device for clamping a fixed part and driving the part to rotate. An adhesive box is slidably connected to the upper end surface of the casing. The box is provided with a glue sticking chamber which is in communication with the clamping cavity. The glue sticking chamber is provided with a glue pulling device for pulling the tape and applying the tape to the part. The power device on the rear side of the gluing device is used for driving the gluing device to move. The gluing chamber is provided with a cutting device on the left side of the gluing device. The cutting device includes a fixed device. A piston cylinder connected to the inner wall on the rear side of the glue cavity, a piston cavity provided in the piston cylinder, a piston slidingly connected to the piston cavity, fixedly connected to a lower end surface of the piston, and downward A pressure bar extending into the clamping cavity, a pressure block fixedly connected to the pressure bar and located in the clamping cavity, fixedly connected to the inner wall on the rear side of the adhesive cavity and located on the pressure block The suction cup on the lower side is fixedly connected to the inner wall of the rear side of the glue cavity and is located at A cylinder on the upper right side of the piston cylinder, an air cavity provided in the cylinder, a sub-slider slidingly connected to the air cavity, fixedly connected to the lower end surface of the sub-slider, and extending downward to the clamp A connecting pipe is connected between the cutting knife in the holding cavity, the auxiliary slide plug and the upper inner wall of the piston cavity, and the downward movement of the auxiliary slide is used to drive the cutting knife down to realize the cutting tape. The air flow generated by the downward movement of the auxiliary slide drives the piston to press down the clamp through the connecting pipe to tightly fix the adhesive tape. The adhesive cavity is provided with a supply of storage and supply tape located on the left side of the cutting device.

2. The sticking device for plastic parts of long rods according to claim 1, characterized in that the sliding resistance between the sticking box and the case is large, so that the sticking is performed during the normal sticking process. There is no slippage between the box and the case.

3. The sticking device for plastic parts of long rod type according to claim 1, characterized in that the clamping device comprises a secondary air pump fixedly connected to the right inner wall of the clamping cavity, and the secondary air pump rotates inside A secondary motor shaft extending back and forth into the clamping cavity is connected, and a secondary motor fixedly connected to an inner wall on the rear side of the clamping cavity is connected to the auxiliary motor shaft on the inner wall on the front side of the clamping cavity. A driven shaft extending rearward is rotatably connected to the driven shaft and the auxiliary motor shaft, respectively, and a sliding cylinder is fixedly connected, and the two sliding cylinders are symmetrical front and rear, and the sliding cylinder on the rear side is located in the On the front side of the auxiliary air pump, a pneumatic cavity is provided in the sliding cylinder, and a sliding plug is slidably connected in the pneumatic cavity. A push rod is fixedly connected to an end surface of the sliding plug near the center of symmetry. A return spring is connected between the inner wall of the pneumatic cavity near the center of symmetry, the push rod extends into the clamping cavity toward the side of the symmetrical center, and a clamp box is fixedly connected to the end surface of the side of the cylinder near the center of symmetry; The clamping box is provided with a clamping cavity, and the push rod Extending to the side of the center of symmetry into the clamping cavity, the push rod is fixedly connected with a trapezoidal block located in the clamping cavity, and two upper and lower symmetry are slidingly connected to the left inner wall of the clamping cavity. A clamping spring is connected between the clamping block and the inner wall of the clamping cavity away from the center of symmetry, and the clamping spring can abut against the trapezoidal block, and the clamping spring can clamp An air pipe is connected between the auxiliary air pump and the pneumatic chamber on the front side, and a connecting pipe is connected between the auxiliary air pump and the pneumatic chamber on the back side.

4. The glue sticking device for plastic parts of long rod type according to claim 3, characterized in that: the gas path pipe is provided with a solenoid valve for exhausting.

5. The glue sticking device for a long-bar type plastic part according to claim 1, wherein the glue pulling device comprises a slide table fixedly connected to an inner wall of the glue sticking chamber, which is located on the right side of the cylinder. A secondary rack is slidably connected to the upper end surface of the slide table, a rear end surface of the secondary rack is fixedly connected, a secondary slide table is fixedly connected to the left end surface of the secondary rack, and the left side of the secondary slide table is fixedly connected. A rack is slidably connected to the end surface, and a secondary suction cup capable of utilizing negative pressure adsorption tape is fixedly connected to the left end surface of the rack. A wedge-shaped block is fixedly connected to the upper end surface of the secondary suction cup. An air pump located on the upper side of the auxiliary rack is fixedly connected to the inner wall, and an auxiliary hose is connected between the air pump and the auxiliary suction cup.

6. The sticking device for plastic parts of long rod type according to claim 5, characterized in that the power device comprises a pulley shaft which is rotatably connected to the inner wall on the rear side of the sticking cavity and extends forward, and the The pulley shaft is located on the right side of the rack. The pulley shaft is fixedly connected with a secondary gear meshing with the rack. The pulley shaft is fixedly connected with a secondary pulley located on the rear side of the secondary gear. A forwardly extending motor shaft is rotatably connected to the inner wall on the rear side of the glue cavity, and the motor shaft is located on the lower right side of the pulley shaft. The motor shaft is dynamically connected to the rear side of the glue cavity. A motor on the inner wall, a pulley is rotatably connected to the motor shaft, a V-belt is connected between the pulley and the auxiliary pulley, and a spline cavity with an opening facing forward is arranged in the pulley. A spline cylinder that can be splined to the spline cavity is connected to the motor shaft by a sliding key, and a gear located on the front side of the spline cylinder is rotatably connected to the motor shaft. And the auxiliary spline cavity which can be splined with the spline cylinder, and Rack gear connected to said secondary, said secondary chamber before anthesis bonds connecting the electromagnet is fixed on the inner wall, said compression spring between the electromagnet and the splined tubular connection.

7. The sticking device for plastic parts of long rod type according to claim 5, characterized in that the cutting device comprises an exhaust pipe fixedly connected to the right end face of the piston cavity and connected to the exhaust pipe, and the exhaust pipe A slide hole with an upward opening is provided on the upper inner wall, and a slide block that can cut off the exhaust pipe is slidably connected in the slide hole, that is, the slide block can prevent the piston cavity and the glue cavity from Communicate with each other, and the sliding block makes the sliding hole not communicate with the exhaust pipe; a lower end surface of the sliding block is fixedly connected with a link extending downwardly to the outside of the exhaust pipe end surface; and A connecting rod can abut the wedge-shaped block, a spring is connected between the piston and the inner wall of the lower side of the piston cavity, and the connecting pipe is provided with two auxiliary check valves distributed from left to right, on the left The secondary check valve is located where the piston cavity communicates with the connecting pipe. A check valve is provided on the lower end surface of the suction cup. An air pipe is connected between the check valve and the air pump. An oblique block on the right side of the cutting blade is fixedly connected to the lower end surface of the auxiliary slider, and the auxiliary slider and the A tension spring is connected between the inner wall on the upper side of the air cavity, and an auxiliary sliding hole with a rightward opening is provided on the inner wall on the right side of the air cavity, and a pusher that can be abutted with the inclined block is slidably connected in the auxiliary sliding hole. A rod, a bump located in the glue cavity is fixedly connected to the upper end surface of the push rod, a hose is connected between the right end surface of the air cavity and the auxiliary air pump, and the hose is connected A valve body communicating with the air cavity is connected, and the valve body is fixedly connected to the right end face of the air cavity, and an inner wall on the upper side of the valve body is provided with a sliding cavity with an opening facing downward, and the sliding cavity An internal slide is connected to the slider which can make the air cavity and the auxiliary air pump not communicate with each other. The slider is provided with an L-shaped hole with an opening facing left and downward. The L-shaped hole is in communication with the glue cavity and can communicate with The air cavity is in communication, and a connecting rod extending downwardly into the glue cavity is fixedly connected to the lower end surface of the slider, and the connecting rod is in contact with the projection, and the right side of the air cavity is connected. A damper located on the lower side of the valve body is fixedly connected to the end surface, and the connecting rod penetrates the damper, and the damper enables the connecting rod There is a large damping when descending, so that the slider moves down slowly, so that the air cavity has enough time to exhaust air through the L-shaped hole, and the hose is provided with a valve located on the right side of the valve body.

8. The glue sticking device for a long rod type plastic part according to claim 7, characterized in that the auxiliary check valve communicates in one direction from top to bottom, and the check valve communicates in one direction from bottom to top through Adjusting the flow rate of the flow valve can control the time for the cutting knife to move the cutting tape down, thereby changing the length of the tape wound on the workpiece.

9. The glue sticking device for plastic parts of long rod type according to claim 7, characterized in that the supply device comprises a subsidiary air pump fixedly connected to the inner wall on the rear side of the glue cavity, and the subsidiary air pump is located in the On the left side of the piston cylinder, an auxiliary air pipe is connected between the auxiliary air pump and the air pipe. The auxiliary air pump is rotatably connected with a conveying shaft that extends forward into the glue cavity, and the conveying shaft is fixedly connected. There is a conveying wheel, and the tape passes around the lower end surface of the conveying wheel. A core shaft located on the upper left side of the conveying shaft is rotatably connected to the inner wall on the rear side of the glue cavity, and the core shaft extends forward. A storage wheel for storing tape is fixedly connected to the shaft.
